(19) United States
(12) Patent Application Publication
(10) Pub. No.: US 2007/0100999 A1
(43) Pub. Date: May 3, 2007

(54) Method, system and software for rendering e-mail messages

(76) Inventor: Faiyaz Haider, Centerville, VA (US)

Correspondence Address: FOLEY AND LARDNER LLP;SUITE 500, 3000 K STREET NW, WASHINGTON, DC, 20007, US

(21) Appl. No.: 11/590,879

(22) Filed: Nov. 1, 2006

Related U.S. Application Data
(60) Provisional application No. 60/731,868, filed on Nov. 1, 2005.

(51) Int. Cl. G06F 15/173

(52) U.S. Cl. 709/225

(57) ABSTRACT

A method, system, and software of displaying an electronic communication, includes rendering an incoming original electronic message into a non-executable format and displaying the non-executable format to a user. An indication is received from the user that has viewed the non-executable format regarding whether the original electronic message should be delivered to the user, and only delivering the original electronic message to the user after receiving the indication from the user that the original electronic message should be delivered to the user.

### RELATED APPLICATIONS

This application claims priority to U.S. provisional patent application 60/731,868, entitled Method, System, and Software for Rendering E-Mail Messages, filed Nov. 1, 2005, which is incorporated in its entirety herein by reference.

### BACKGROUND OF THE INVENTION

1. Technical Field

The present invention relates to converting and rendering selective inbound electronic messages in a safer format in a client application for reading the messages.

2. Background of the Invention

Almost all email systems in existence allow dissemination of email messages to the end users that contain electronic attachments (e.g., documents, images, hypertext links, etc.). An end user can utilize a myriad of email clients that range from proprietary email clients (thick clients) to web-based interfaces that retrieve email messages. Once retrieved through any of the aforementioned email clients, the email can be viewed at the end user's terminal (i.e., a desktop, laptop, hand-held, etc.), including the attachments. In some cases, these attachments may contain malicious code (e.g., Virus, Trojan Horse, etc.) that may automatically execute itself on the end user's machine without end user's knowledge causing system failure or system infection.

In order to avoid such malicious code from affecting the end user's system, most administrators implement anti-virus applications at the email server and/or at the end user's desktop. In either case, such malicious code prevention and remediation technologies (i.e., anti-virus applications) require constant updating of the definition/database files that contain the identity of the malicious code (i.e., virus definition files). Therefore, it is possible for a newly developed virus to circumvent an enterprise's virus protection if its virus definition is not contained within the virus definition database—either on the server or the client. Opening, and in some cases simply viewing the infected email message that has circumvented an older virus definition database can not only affect a single end user, but in most cases spread it to other email systems extremely rapidly.

### SUMMARY OF THE INVENTION

In certain embodiments, the present invention provides a computer implemented method of displaying an electronic communication, that includes: rendering an incoming original electronic message into a non-executable format; displaying the non-executable format to a user; receiving an indication from the user that has viewed the non-executable format regarding whether the original electronic message should be delivered to the user; and only delivering the original electronic message to the user after receiving the indication from the user that the original electronic message should be delivered to the user.

In certain embodiments, the electronic message in an electronic mail message.

In certain embodiments, the step of rendering comprises converting the original incoming electronic mail message into a format that only consists of (1) a graphic, (2) text, or (3) a combination of a graphic and text.

Certain embodiments further include an earlier checking whether the incoming electronic mail message requires to be rendered into a non-executable format and only rendering into the non-executable format if indicated by the checking.

In certain embodiments, the checking is performed automatically by using automated rules.

In certain embodiments, the checking is performed based on a rule sets selectable by the user.

In certain embodiments, the rendering is performed at an e-mail server of an organization before being forwarded to a user of the organization's e-mail service.

In certain embodiments, the rendering is performed either at a computer used by an individual user or at an e-mail service provider site that provides e-mail service to the individual user.

Certain embodiments provide a computer readable medium having program code recorded thereon, that when executed causes a computing system, to display an electronic communication, the program code includes: code for rendering an incoming original electronic message into a non-executable format; code for displaying the non-executable format to a user; code for receiving an indication from the user that has viewed the non-executable format regarding whether the original electronic message should be delivered to the user; and code for only delivering the original electronic message to the user after receiving the indication from the user that the original electronic message should be delivered to the user.

Certain embodiments provide a system for displaying an electronic communication, including: an electronic mail server configured to include: a rendering unit that renders an incoming original electronic message into the non-executable format and transmits the non-executable format for display to a user; and a processing unit that receives an indication from the user that has viewed the non-executable format regarding whether the original electronic message should be delivered to the user, and for only delivers the original electronic message to the user after receiving the indication from the user that the original electronic message should be delivered to the user.

Certain embodiments provide a system for displaying a electronic mail message including a display unit configured with: a first indicator that requests that an original e-mail be rendered into a non-executable format; a preview pane to preview the e-mail in the non-executable format; a second indicator that requests delivery of the original e-mail to the display unit.

### BRIEF DESCRIPTION OF THE DRAWINGS

The accompanying drawings, which are incorporated in and constitute a part of the specification, illustrate embodiment(s) of the invention, and together with the general description given above and the detailed description of the various embodiment(s) given below, serve to explain various aspects of the invention.

FIG. 1 is a flow diagram that illustrates certain embodiments for interception and rendering of an inbound email message.

FIG. 2 is an diagram that illustrates exemplary components used by individual email recipients.

FIG. 3 is a diagram that illustrates exemplary components used by organizational email recipients.

FIG. 4 illustrates an exemplary email client interface.

FIG. 5 illustrates a generic computing system diagram that may be used with certain embodiments.

### DETAILED DESCRIPTION OF THE VARIOUS EMBODIMENTS

In certain embodiments, the present invention eliminates the possibility of electronic virus infection that has been propagated via email systems completely by converting selective email messages into a safer format, such as a graphic or ASCII text format (which are non-executable formats) and then presenting to an end user through end user's choice of email client interface. In certain embodiments, the present invention provides that this conversion can take place either at the server level or at the end user's computer. It should be understood that user and end-user are used interchangeably in the present application. The embodiments that perform the conversion at the end user's client is based on the fact that there are a majority of users that do not utilize commercially available servers for processing email and therefore the conversion is most feasible at the end user's computer. However, one skilled in the art would recognize that even in the case of the individual users, the Internet Service Provider (or other e-mail service provider) may provide this conversion at their site so that all of their individual users (or a subset of their users that subscribe to the rendering service) may receive a rendered e-mail message in a safer format (such as a non-executable format) as provided in this application. However, users that only utilize a single email box, provided to them by either their Internet Service Provider (ISP) or some other organization that may not use this invention, may need the conversion to occur on their computer.

In certain embodiments, the term “selective messages” herein refers to either an email server administrator or an individual's ability to define what types of messages require conversion to a graphical format (i.e., a rule set). For example, an end user or an email administrator could decide that all inbound email messages that contain only text within the message body need not be converted to a graphic or ASCII text representation of the original inbound email for final presentation through the email client. Alternatively, in certain embodiments, intelligence could be built into the system so that it could automatically determine which messages to render in a safer format versus which allowing other messages to the end-user with full electronic fidelity. For example, this automated selection could be done on the basis of the sender information and/or based on the content of the message (for example, the presence of certain keywords).

The end user, after having viewed and deemed the inbound message to be safe, is subsequently able to retrieve the message with its full electronic fidelity (i.e., all attachments, links, etc.) by utilizing an interface that is added to the end user's email client.

Therefore, certain embodiments of the present invention are directed to improving email security by denying the ability of an infected inbound email message to corrupt an end user's computing platform.

It should also be recognized that while certain embodiments relate to rendering an electronic mail in a safer format, the principles of the present invention can also be applied to other similar electronic communication modes. For example, messaging, instant messaging, or other similar electronic communication modes in which attachments or executables can be transmitted may also be adapted with the techniques disclosed herein.

In certain embodiments, the present invention provides for rendering of selective inbound email messages into graphical or ASCII text format prior to retrieval of the selective inbound messages by the end users utilizing their email client applications. These features provided by the present invention is described generally in the context of conversion of inbound email from its original format to a safer format, such as a graphical or ASCII text format, for delivery to an end user. Specifically, these embodiments secure the end user's computer by converting the entire content of the selective email message into a type of electronic format (such as a non-executable format), which would eliminate introduction of malicious code to the end user's desktop since the end user verifies whether the rendered email message should be retrieved in its original format before the e-mail message is retrieved and presented to the user with its full electronic fidelity.

This conversion can either be accomplished at the email gateway or at the end user's email client. Since all email transmission relies on standards-based store-and-forward routing of internet-based email gateways, in certain embodiments, the present invention utilizes the existing electronic communication infrastructure. Utilization of well defined email routing protocols such as SMTP (Simple Mail Transfer Protocol) and the ITU (International Telecommunication Union) X.400 eliminates any need for modifying the underlying email infrastructure to support the system and method disclosed herein. The integrity of a routed email message over the internet (or other similar public or private network or internetwork) between and amongst the senders and the receivers of the email messages is fully maintained. The disclosed system and method leverages the existing standards in order to intercept and subsequently convert the selective inbound message while saving and maintaining the original message with its full electronic fidelity.

System Overview

In certain embodiments, the method and system disclosed herein provides for the interception, conversion (to a safer format such as either text or graphic format or a combination thereof) and delivery of inbound email messages that, in their entirety, do not consist of plain ASCII text format. A premise of the method and system disclosed herein is that this conversion will effectively neutralize the electronic payload (e.g., file attachments, viruses, links, etc.). Only the intended user will have the ability to request the email and its associated electronic payload after reviewing the rendered inbound email—either as a text message or a graphic rendering of the electronic payload.

All email routing (traversal through either the Internet or an organization's public or private network) is predominantly based on standards-based routing protocols such as SMTP and X.400. It should be recognized that these e-mail standards are exemplary only and the principles of the present invention would work with other similar electronic communication standards that are known or may be developed in the future. The method and system disclosed herein leverages these existing standards and therefore does not require any substantial changes to the overall email transmission infrastructure.

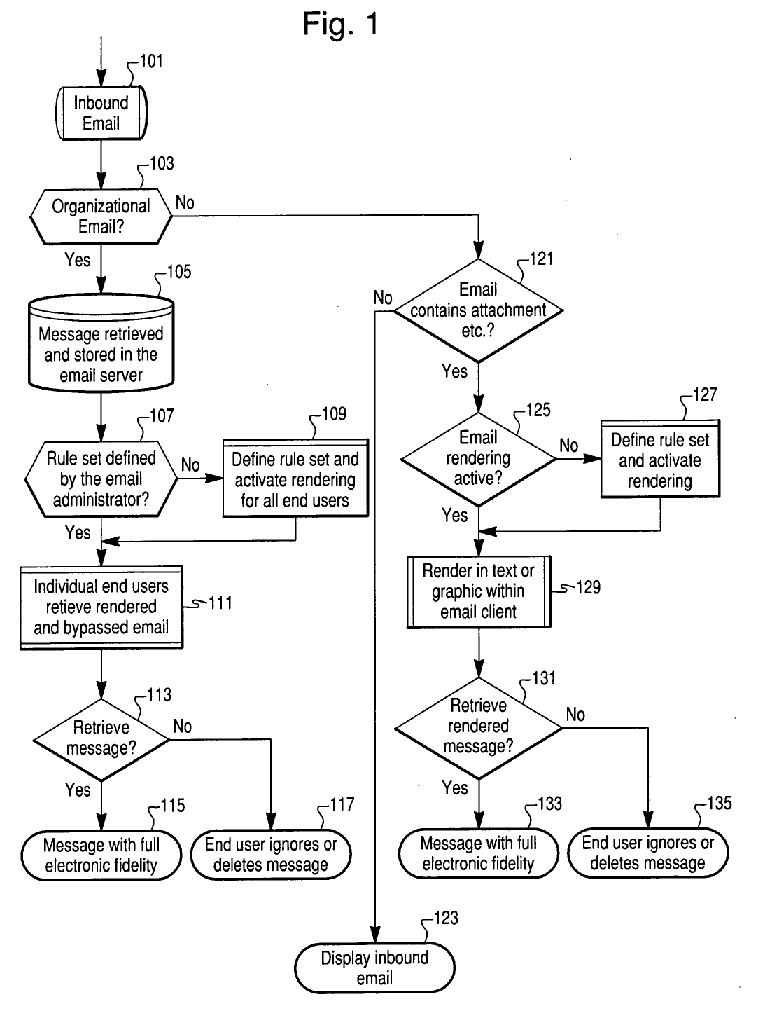

FIG. 1 is flow diagram that illustrates the process flow of an inbound email system and how that email is intercepted and processed based upon whether the email was retrieved by an organizational user (i.e., utilizing organizational email server and connectivity) or an individual user who will most likely be retrieving his or her email from an Internet Service Provider (e.g., Hotmail, Yahoo mail, Post Office Protocol 3 (POP-Version 3), etc.). It should be recognized that FIG. 1 is exemplary only. One skilled in the art would recognize various modifications and alternatives, all of which are all considered as a part of the present invention.

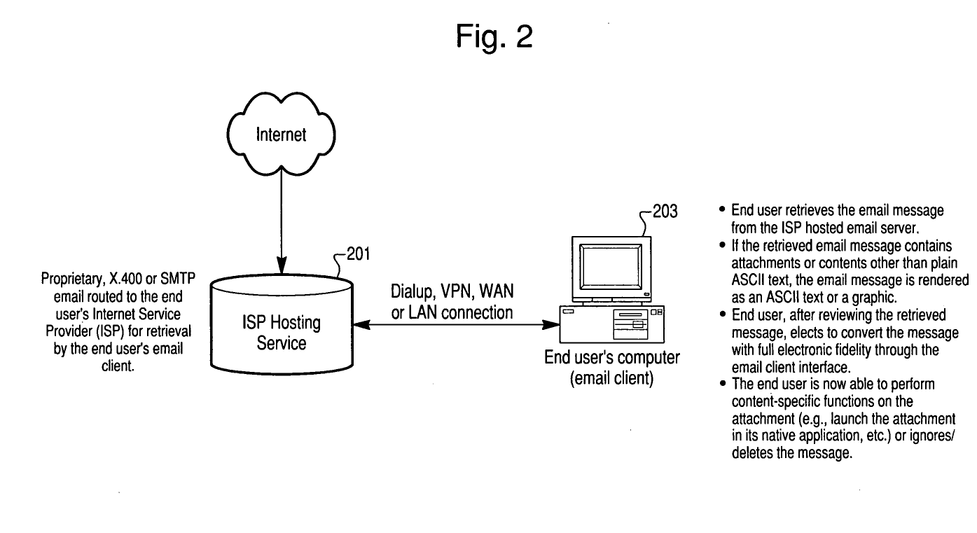

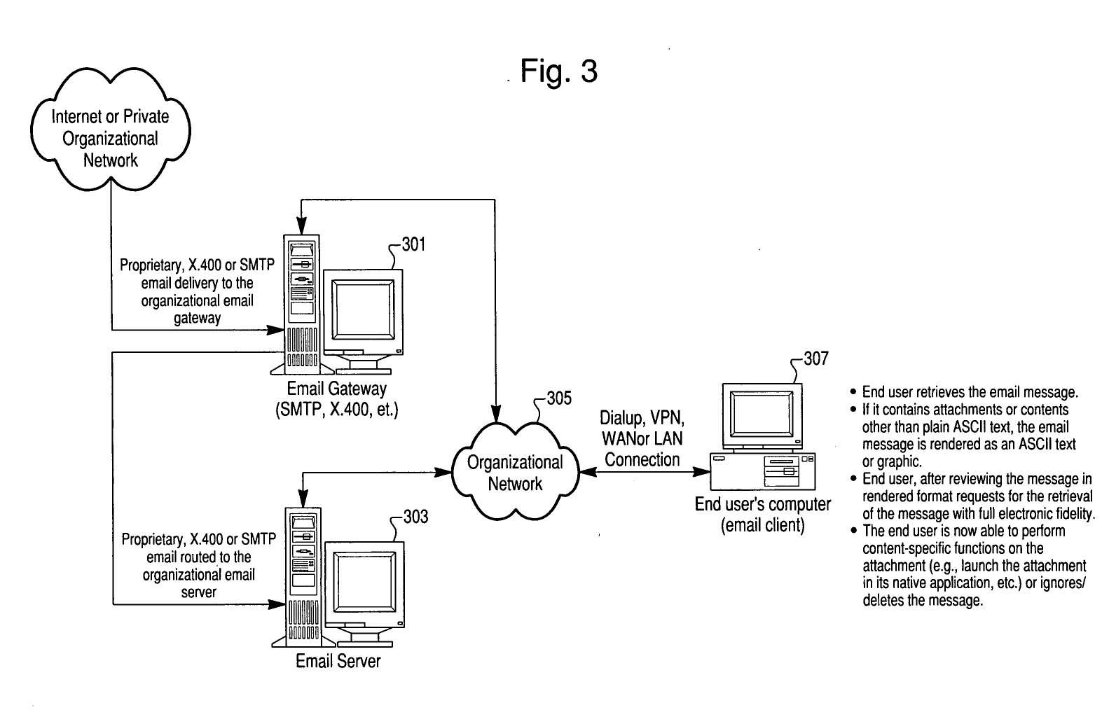

FIGS. 2 and 3 disclose the components that process the electronic mail for individual e-mail recipient and for a corporate e-mail, respectively. It should be noted that FIGS. 2 and 3 are exemplary only and one skilled in the art would recognize various modifications and alternatives which are all considered as a part of the present invention.

Organizational Email Processing

Almost all organizations that provide email services to their end users rely on some commercial email server (e.g., Microsoft Exchange, Lotus Domino, Novell Groupwise, etc.). Generally, these email servers retrieve email from email servers that belong to other organization (e.g., a person sending an email message from Corporation X to another user in Corporation Y) or from other email servers that belong to the same organization (e.g., two users working in Corporation X exchanging email between each other).

Regardless of the organizational boundaries, an inbound email message arrives inside the organization email system gateway in step 101 and is subsequently routed to and stored in the email server in steps 103 and 105. One skilled in the art would recognize that an implementation in a corporate setting may omit step 103 since it is reasonable to assume that all e-mail addressed to its e-mail server is organizational e-mail. As shown in FIG. 3, the e-mail would be received in the e-mail gateway 301 and stored in the e-mail server 303. It should be noted that the gateway and server are shown as separate boxes in the figure. One skilled in the art would recognize that these are logical separations while any one of several physical implementation could be used as would be within the abilities of one skilled in the art. Furthermore, one skilled in the art would recognize that the e-mail server 303 may be configured with software that would implement a rendering unit that renders the non-executable format to a user and processing unit that performs the remaining processing as described herein.

The e-mail is stored in the e-mail server 303 until an end-user initiates retrieval of the e-mail. In steps 107 and 109, the system and method provided herein checks to see whether a rule set has been defined by the user (with respect to which e-mails to select for rendering) and if not, the user is provided the prompts and options to define or select the rule sets that govern the rendering process. Alternatively, as discussed earlier herein, the decision rules on whether to render an incoming e-mail message may be automated, or in another alternative, a hybrid system may be used wherein the user may select some of the rules while some of the other rules may be implemented automatically. Typically, in an organizational email service, the organization's email administrator has to define the rule sets for intercepting the email. For example, a rule set with a logic that all inbound email messages, regardless of the end users, that have any electronic payload (i.e., attachment, link, Rich Text Formatting, etc.) must be rendered to the end users by sending as either ASCII text or a graphic that renders the attachments and that the end users will have to request the original email message manually through their email client interface. These rule sets could be implemented globally within the organization or more granularly (for example, they could be set at departmental levels or they could be set based on the roles associated with the users), based upon an organization's tolerance to the risk associated with viruses that can be proliferated, either deliberately or unintentionally, within the organization.

One example of the rendering process could be to convert the entire e-mail including any links or any attachments in the e-mail into a graphic so that a user can see the entire e-mail substantially as it would have appeared if the e-mail had been presented directly to that user. However, any links or attachments that could be executed in the original e-mail would now be rendered non-executable so that the end-user may not inadvertently click on these links or attachments and thereby infect his computer or the network to which the computer is connected.

It should be understood that, in certain embodiments, the rendering process could be performed in step 105 so that all incoming e-mail messages are rendered in a safe format (either as all text or as a graphic or a combination thereof). Alternatively, the rendering could also be performed as a part of step 111 so that only the e-mail messages that need to be rendered are rendered at this stage. This would make sense in a situation where most of the e-mails are trusted (for example, they originate within an organization) and only a few e-mails are termed potentially risky (for example, e-mails that originate from outside the organization).

In step 111, the user would then retrieve the rendered or any bypassed e-mails. As shown in FIG. 3, the user on a computer system 307 would access the e-mail server 303 using the organizational network 305 in order to retrieve the rendered and/or bypassed e-mails. Thereafter, the end-user views the rendered message and in step 113 makes the decision whether the original e-mail should be presented to him in its full electronic fidelity. If yes, in step 115, the e-mail is presented to the user in its full electronic fidelity. Otherwise, in step 117, the original e-mail message is ignored and not presented to the user in its full electronic fidelity. Furthermore, any messages that did not meet the rule set criteria established by the organization's email administrators (i.e., they were not selected for rendering) bypass the conversion process performed at step 105 so that the original e-mail is presented when the end user retrieves the messages at step 113.

Individual Email Use

The individual email users, as discussed herein, are defined as individuals that rely on third-party organizations referred to as Internet Service Providers (ISPs) for sending and receiving email messages. Therefore, these individuals do not maintain an email server. Instead, these individual users utilize email clients for submitting and retrieving email messages to and from the ISPs respectively. The inbound messages can be retrieved through a preferred thick email client (e.g., Eudora, Microsoft Outlook, Lotus Notes, etc.). However, almost all of the ISPs now provide a web-based interface. An email end user simply needs to point his or her browser to the email server hosted by the ISP and retrieve their email over the Internet's through the web interface.

Whether an email end user retrieves his or her email through a thick client or via the web, as shown in FIG. 1, the method and system provided herein intercepts the retrieved email at the user's email interface and examines whether there are any attachments in step 121. If there are no attachments (i.e., electronic payload), the inbound email bypasses the conversion process and is delivered to the end user's email box as shown in step 123. Otherwise (if there are attachments or links, etc. that may lead to an executable code), the email interface examines whether rule sets are in place for interception of inbound email messages with electronic payload at step 125. If not, at step 127, the end user is prompted to create rule sets before he or she is allowed to retrieve the message from the ISP. Once the rule sets are created, the end user is able to retrieve rendered inbound email in step 129. Thereafter, in step 131, the user reviews the rendered e-mail (that is the e-mail rendered in a safer format such as a text message or a graphic or a combination thereof) and indicates whether the message should be delivered with full fidelity in step 133 or whether the message should be ignored or otherwise disposed off in step 135.

As shown in FIG. 2, the email conversion process (i.e., the rendering process) can be accomplished at the servers 201 hosted by the ISP or at the end users' email client computing device 203.

Email Client Interface

To effectively implement the methods and system disclosed herein, changes are required to the end user's email client interface, such that the end user is able to retrieve those messages that arrives in the end user's email box converted (or rendered in a safer format either as ASCII text or graphically). Therefore, in certain embodiments, a conversion function 405 is added in the email interface 401 that is used by the end user so that the converted version can be viewed in the preview pane 403. Some viruses have been able to infect an end user's computer simply when the user previews the inbound message in a preview pane such as the preview pane 403. However, with the rendered message being displayed in the preview pane 403, this possibility of virus infection while previewing an inbound message is eliminated.

Generalized Computing System Diagram

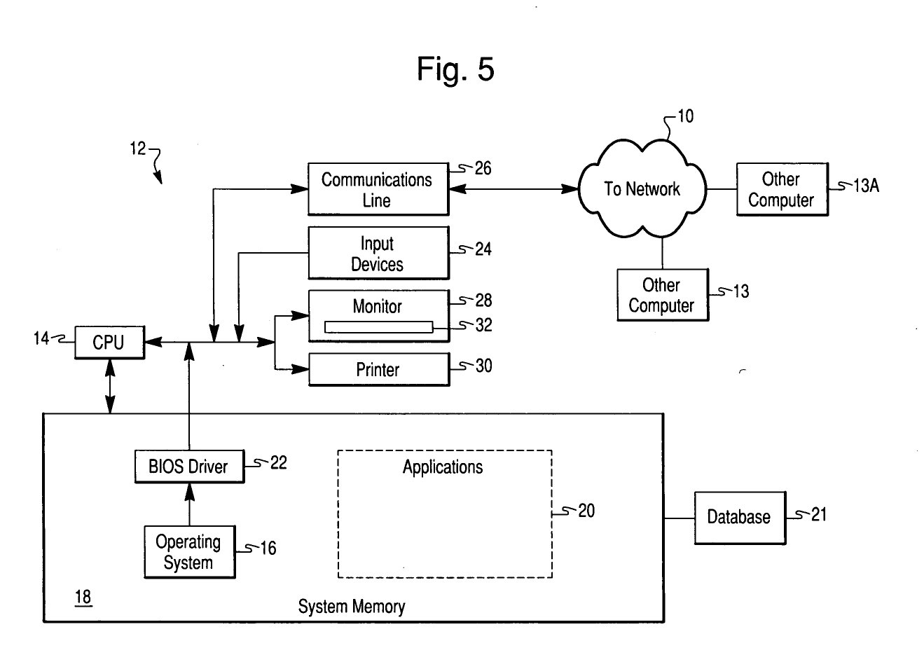

FIG. 5 illustrates the components of a generic computing system connected to a general purpose electronic network 10, such as a computer network. The computer network can be a virtual private network or a public network, such as the Internet. As shown in FIG. 5, the computer system 12 includes a central processing unit (CPU) 14 connected to a system memory 18. The system memory 18 typically contains an operating system 16, a BIOS driver 22, and application programs 20. In addition, the computer system 12 contains input devices 24 such as a mouse or a keyboard 32, and output devices such as a printer 30 and a display monitor 28, and a permanent data store, such as a database 21. The computer system generally includes a communications interface 26, such as an ethernet card, to communicate to the electronic network 10. Other computer systems 13 and 13A also connect to the electronic network 10 which can be implemented as a Wide Area Network (WAN) or as an internetwork, such as the Internet. Data is stored either in many local repositories and synchronized with a central warehouse optimized for queries and for reporting, or is stored centrally in a dual use database.

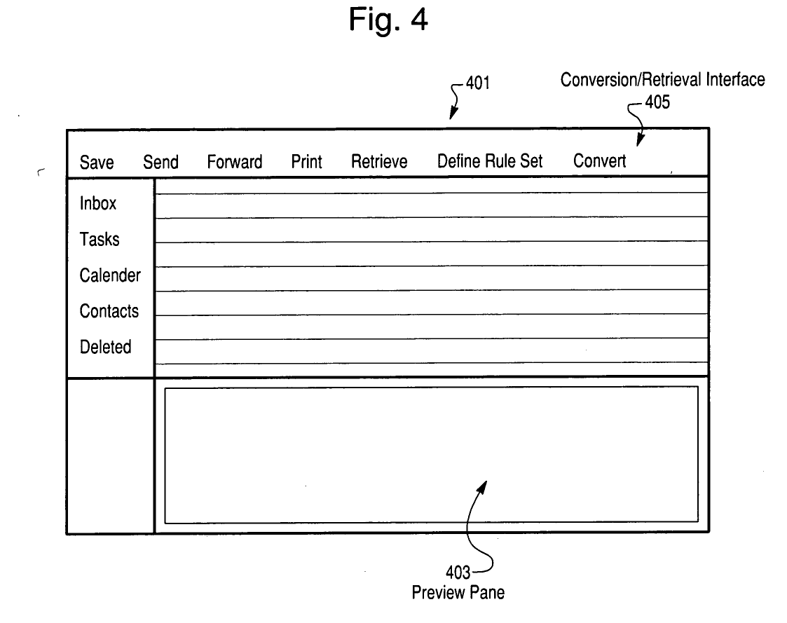

One skilled in the art would recognize that the foregoing describes a typical computer system connected to an electronic network. It should be appreciated that many other similar configurations are within the abilities of one skilled in the art and it is contemplated that all of these configurations could be used with the methods and systems of the present invention. Furthermore, it should be appreciated that it is within the abilities of one skilled in the art to program and configure a networked computer system to implement the method steps of the present invention, discussed earlier herein. For example, such a computing system could be used to implement the method of rendering e-mail messages in safer formats (such as a non-executable format) as discussed earlier herein with respect to FIGS. 1-4.

The present invention also contemplates providing computer readable data storage means with program code recorded thereon (i.e., software) for implementing the method steps described earlier herein. Programming the method steps discussed herein using custom and packaged software is within the abilities of those skilled in the art in view of the teachings disclosed herein.

Other embodiments of the invention will be apparent to those skilled in the art from a consideration of the specification and the practice of the invention disclosed herein. It is intended that the specification be considered as exemplary only, with such other embodiments also being considered as a part of the invention in light of the specification and the features of the invention disclosed herein.

What is claimed is:

1. A computer implemented method of displaying an electronic communication, comprising the steps of:
rendering an incoming original electronic message into a non-executable format;
displaying the non-executable format to a user;
receiving an indication from the user that has viewed the non-executable format regarding whether the original electronic message should be delivered to the user; and
delivering the original electronic message to the user after receiving the indication from the user that the original electronic message should be delivered to the user.

2. The computer implemented method according to claim 1, wherein the electronic message in an electronic mail message.

3. The computer implemented method according to claim 2, wherein the step of rendering comprises converting the original incoming electronic mail message into a format that only consists of (1) a graphic, (2) text, or (3) a combination of a graphic and text.

4. The computer implemented method according to claim 2, further comprising:
an earlier step of checking whether the incoming electronic mail message requires to be rendered into a non-executable format and only rendering into the non-executable format if indicated by the step of checking.

5. The computer implemented method according to claim 4, wherein the step of checking is performed automatically by using automated rules.

6. The computer implemented method according to claim 4, wherein the step checking is performed based on a rule sets selectable by the user.

7. The computer implemented method according to claim 2, wherein the step of rendering is performed at an e-mail server of an organization before being forwarded to a user of the organization's e-mail service.

8. The computer implemented method according to claim 2, wherein the step of rendering is performed either at a computer used by an individual user or at a e-mail service provider site that provides e-mail service to the individual user.

9. A computer readable medium having program code recorded thereon, that when executed causes a computing system, to display an electronic communication, the program code comprising:
code for rendering an incoming original electronic message into a non-executable format;
code for displaying the non-executable format to a user;
code for receiving an indication from the user that has viewed the non-executable format regarding whether the original electronic message should be delivered to the user; and
code for delivering the original electronic message to the user after receiving the indication from the user that the original electronic message should be delivered to the user.

10. The computer readable medium according to claim 9, wherein the electronic message in an electronic mail message.

11. A system for displaying an electronic communication, comprising:
an electronic mail server configured to include:
a rendering unit that renders an incoming original electronic message into a non-executable format and transmits the non-executable format for display to a user; and
a processing unit that receives an indication from the user that has viewed the non-executable format regarding whether the original electronic message should be delivered to the user, and for only delivers the original electronic message to the user after receiving the indication from the user that the original electronic message should be delivered to the user.

12. The system according to claim 11, wherein the electronic message in an electronic mail message.

13. A system for displaying a electronic mail message, comprising:
a display unit configured with:
a first indicator that requests that an original e-mail be rendered into a non-executable format;
a preview pane to preview the e-mail in the non-executable format;
a second indicator that requests delivery of the original e-mail to the display unit.
